(19) United States
(12) Patent Application Publication
(10) Pub. No.: US 2008/0201743 A1
(43) Pub. Date: Aug. 21, 2008

(54) Method For Facilitating the Watching of Tv Programs, Dvd Films and the Like, Meant For Deaf People and People With Hearing Damage

(76) Inventors: Benjamin Gordon Stevens, Victoria (AU); Kurt Schnepf, Victoria (AU)

Correspondence Address: FASTH LAW OFFICES (ROLF FASTH), 26 PINECREST PLAZA, SUITE 2, SOUTHERN PINES, NC, 28387-4301, US

(21) Appl. No.: 11/571,225

(22) PCT Filed: Jun. 24, 2004
(86) PCT No.: PCT/FI2004/000389

§ 371 Date: Dec. 20, 2007

(51) Int. Cl. G06F 3/00

(52) U.S. Cl. 725/46

(57) ABSTRACT

The method is for facilitating the watching of films, TV programs and the like, meant for deaf people and people with hearing impairment. The method allows a transparent or translucent shadow-graph to be produced on the screen.

### TECHNICAL FIELD

The subject matter of the present invention is the method according to the preamble of claim 1.

Thus, the present invention is concerned with the presentation of gestures of sign language in different digital environments, such as television, video, DVD, and with special equipment at movie theaters.

### BACKGROUND ART

Gestures of sign language are the native language of deaf children and children with hearing damage, and before these children learn how to read, they need programs that are presented in sign language. The society is obliged to produce these programs.

The presently used method is the so called sign window. It is a box shown on the picture, in which a person interpretes the dialogue or what is happening on the show to the viewer with gestures of sign language. The movie “Rölli ja metsänpeikko” has been produced in this way. The drawbacks of this method are that a) the window effectively covers part of the whole picture screen and b) while the viewer is observing the signs, he/she can not fully concentrate on what is shown in the movie or other program. Unlike with subtitles, where it is possible for the viewer to learn how to read multiple sentences simultaneously, a person has to follow the sings constantly.

The object of the present invention is to achieve an improvement on the presently known method and avoid the drawbacks of the present method.

The object of the present invention can be achieved by a method, which is characterized by the characteristic features presented in the characterizing part of claim 1.

The invention cleverly uses so called lap dissolve technology in a new, surprising way. A shadow graph, of for example signing hands, is set on (or behind) the picture. The interpretation in sign language can also be facial expressions, or signing hands together with facial expressions. The gestures are transparent, so they do not cover any part of the picture area. The viewer sees the picture and the signs on top of each other and can read the sings without having to concentrate fully on them.

A sign can have the size of the whole screen or it can be smaller depending on the situation. It can be removed from faces for example. Subtitling in sign language can be used in all digital picture formats. The signs are stored in an appropriate place in digital form. In television, the signs can be accessed through teletext pages, in DVD environments they can be found from their own menu just as the other subtitles in different languages. The signs can have their own track on video and with supplementary apparatus, the method is suitable to be used also in movie theaters.

The invention is explained more thoroughly by referring to one advantageous embodiment of the invention presented in the figures in the enclosed drawing, although the invention is not meant to be limited to only this embodiment.

### FIGURES

FIG. 1 presents the program seen on the screen.

FIG. 2 presents the digitally stored sign language interpretation.

FIG. 3 presents the program shown on the screen according to FIG. 1 accompanied with a transparent shadow graph of the sign language interpretation according to FIG. 2.

### DETAILED DESCRIPTION

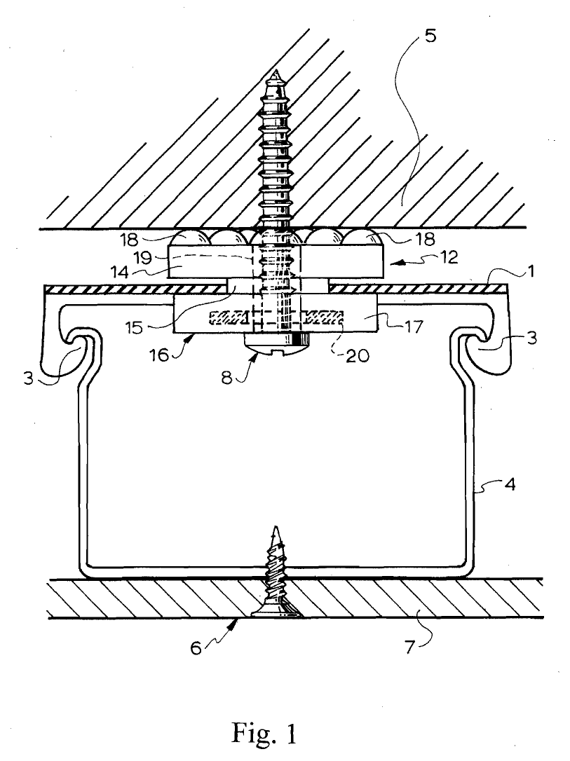

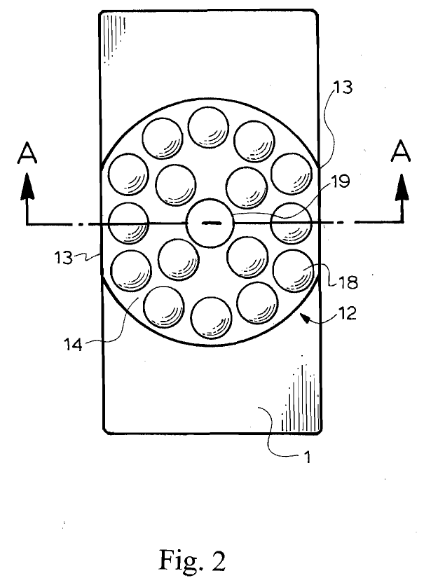

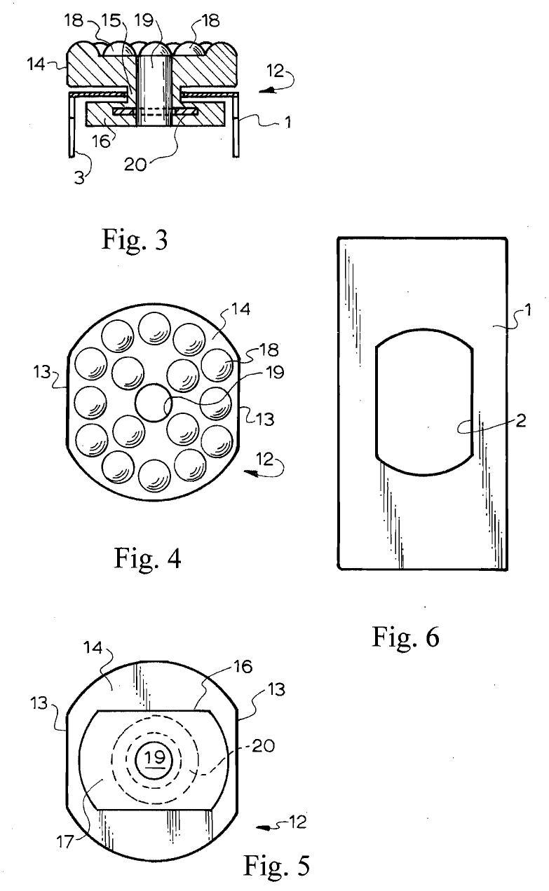

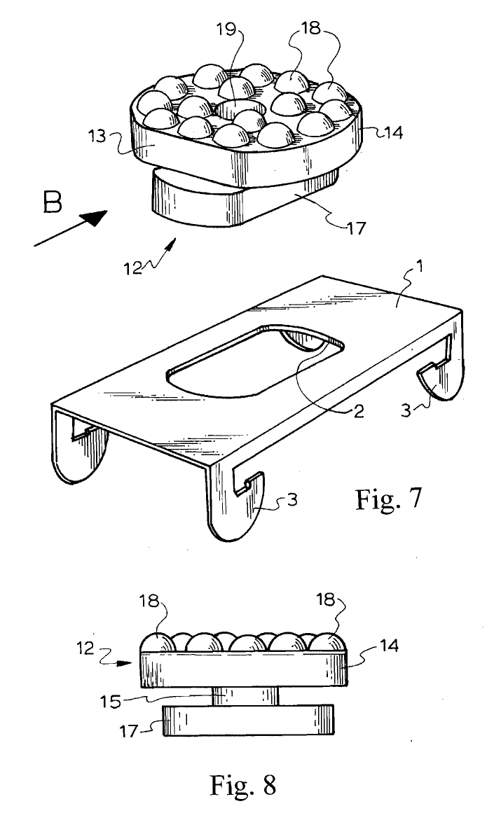

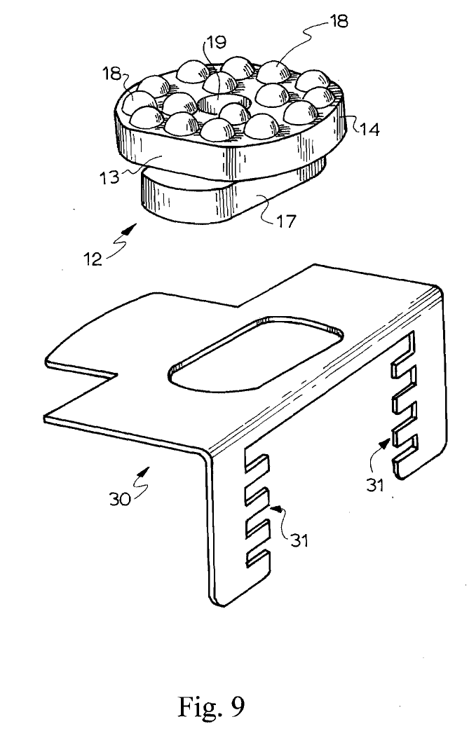

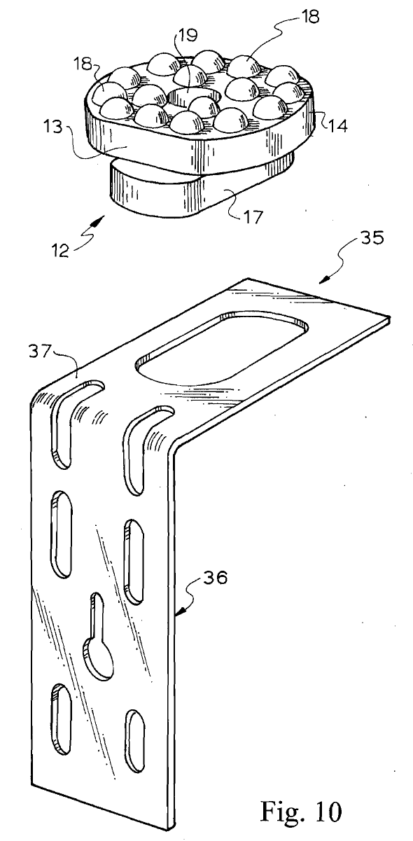

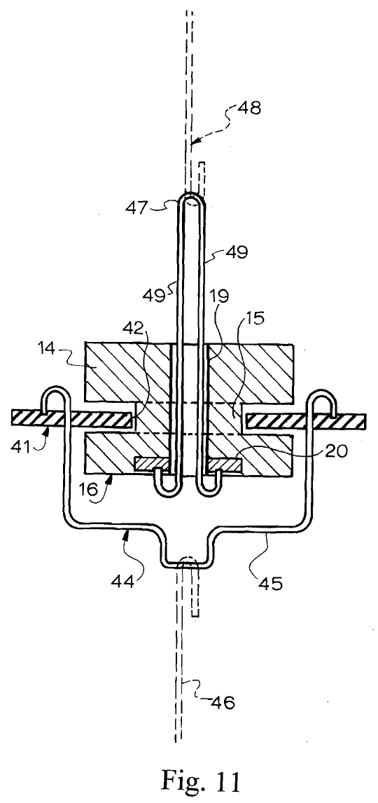

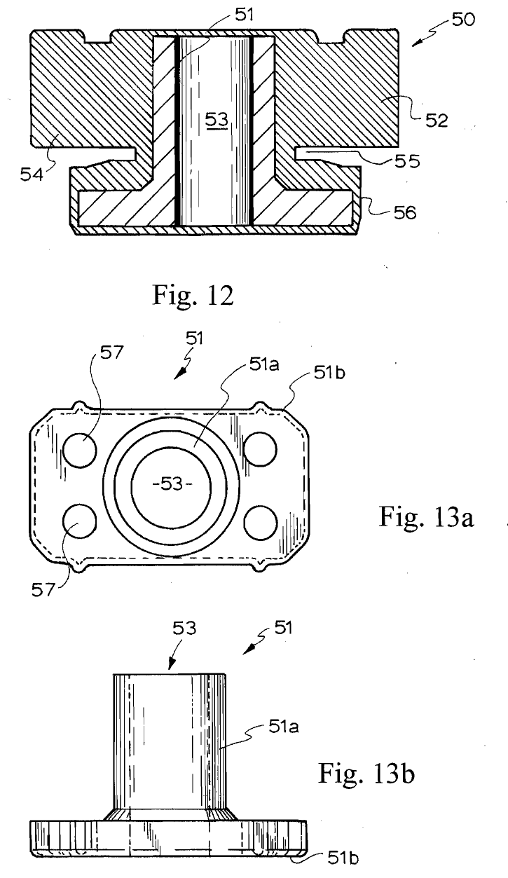

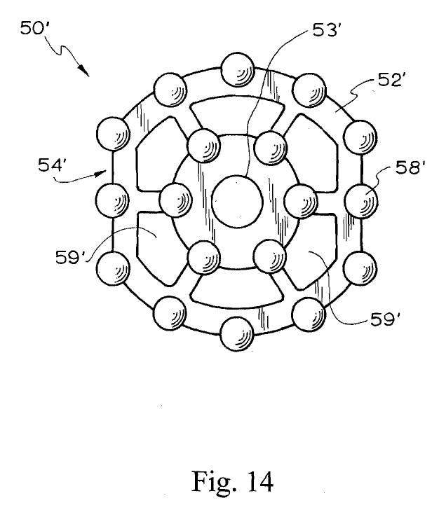

In the embodiment of the invention according to FIGS. 1-3, the program shown on the screen, which can be a tv program, a dvd program, movie or the like, is marked with reference number 11. The digitally stored sign language interpretation is marked with reference number 12. From FIG. 3 it can be seen how a deaf person or a person with hearing damage observes the tv program 11 accompanied with the sign language interpretation 12 as tv program 13 interpreted according to the invention.

What is described above is only the principle of the invention and some of its applications. It is obvious for one skilled in the art that the details of the invention may vary significantly within the scope of the inventive idea presented in the enclosed claims.

1. A method for facilitating the watching of programs shown on a screen, meant for deaf people and people with hearing damage, comprising;
producing a transparent shadow graph functioning as a sign language interpretation on the screen.

2. The method according to claim 1, wherein a size of the shadow graph is changeable.

3. The method according to claim 1 wherein the shadow graph is moved on the screen.

4. The method according to claim 1 wherein the shadow graph is formed of signing hands, facial expressions separately or signing hands together with facial expressions.

5. The method according to claim 1 wherein the sign language interpretation is stored in a digital form.
